(19) United States
(12) Patent Application Publication
(10) Pub. No.: US 2009/0292390 A1
(43) Pub. Date: Nov. 26, 2009

(54) OPERATING DEVICE FOR OPERATING A MACHINE TOOL

(75) Inventor: RALF FRIEDRICH, Herzogenaurach (DE)

Correspondence Address: Henry M. Feiereisen;Henry M. Feiereisen, LLC, Suite 1501, 708 Third Avenue, New York, NY, 10017, US

(73) Assignee: Siemens Aktiengesellschaft, Munchen (DE)

(21) Appl. No.: 12/467,612

(22) Filed: May 18, 2009

(30) Foreign Application Priority Data
May 21, 2008 (EP) EP08009394

(51) Int. Cl. G05B 19/19; G06F 3/041

(52) U.S. Cl. 700/180; 178/18.03

(57) ABSTRACT

An operating device for operating a machine tool has a touch-sensitive contact area and is constructed to generate in response to a contact by an element upon the contact area over a length an output signal in correspondence to the length for controlling a movement of a machine element in a direction of an axis of the machine tool. The operating device is insensitive to particles of dirt, liquids and/or gases which surround the operating device.

### CROSS-REFERENCES TO RELATED APPLICATIONS

This application claims the priority of European Patent Application, Serial No. EP08009394, filed May 21, 2008, pursuant to 35 U.S.C. 119(a)-(d), the content of which is incorporated herein by reference in its entirety as if fully set forth herein.

### BACKGROUND OF THE INVENTION

The present invention relates to an operating device for operating a machine tool.

The following discussion of related art is provided to assist the reader in understanding the advantages of the invention, and is not to be construed as an admission that this related art is prior art to this invention.

Movements of a movable machine element, which may be in the form of a spindle motor for example, can be carried out on machine tools in a so-called manual mode. One method which is often used in this case is to move the machine element in the direction of an axis of the machine tool using a handwheel. Operating devices for operating machine tools often therefore have handwheels, the operating devices either being able to be mounted permanently on the machine tool or being in the form of so-called handheld operating devices which make it possible to operate the machine tool irrespective of location in a particular contact area around the machine. In this case, in commercially available operating devices, the handwheel is in the form of a mechanical handwheel in which the handwheel is rotatably arranged with respect to the housing of the operating device. Particles of dirt, liquids and gases may enter the operating device in a relatively simple manner via the gap between the handwheel and the stationary housing, which gap inevitably arises as a result of the necessary rotational movement, and may damage the sensitive electronics inside the operating device, which may result in failure of the operating device or in malfunctions. Particles of dirt, liquids and gases which are produced, for example, by the operation of machining the workpiece often arise, in particular, in the contact area surrounding machine tools.

Touch-sensitive contact areas which may be in the form of so-called touch pads, for example, are known from the PC sector. In the PC sector, such touch-sensitive contact areas are used to avoid the otherwise necessary connection of an external mouse for the purpose of operating the mouse pointer.

It would therefore be desirable and advantageous to provide an improved an operating device for operating a machine tool to obviate prior art shortcomings and to construct it so as to be insensitive to particles of dirt, liquids and/or gases which surround the operating device.

### SUMMARY OF THE INVENTION

According to one aspect of the present invention, an operating device for operating a machine tool includes a touch-sensitive contact area and is constructed to generate in response to a contact by an element upon the contact area over a length an output signal in correspondence to the length for controlling a movement of a machine element in a direction of an axis of the machine tool.

The present invention resolves prior art problems by using a touch-sensitive contact area for operating a machine tool instead of conventional handwheels. This results in the surprising effect, for a person skilled in the art, that touch-sensitive contact areas can be sealed in a very effective manner with respect to the housing of the operating device, with the result that ingress of particles of dirt, liquids and gases into the operating device is reliably prevented.

The use of a touch-sensitive contact area means that there is no longer any need for a component which rotates with respect to the housing of the operating device in order to operate the machine tool.

According to another advantageous feature of the present invention, the operating device may have a single axis selection operating element for selecting the axis. As an alternative, the operating device may be configured for controlling a movement of the machine element in a direction of three axes defined as x axis, y axis and z axis, and has a plurality of axis selection operating elements which are assigned to the three axes in one-to-one correspondence. In this way, the operator is able to simply select in which axis direction the machine element is intended to be moved.

According to another advantageous feature of the present invention, a proportionality factor selection operating element may be provided for selecting a proportionality factor. This easily makes it possible for the operator to select which length, over which the operator slides e.g. his finger over the touch-sensitive contact area, corresponds to which travel distance over which the machine element is intended to be moved in the direction of the selected axis of the machine tool.

According to another advantageous feature of the present invention, a plurality of touch-sensitive contact areas may be provided to generate in response to a contact by the element upon one of the contact areas over a length an output signal in correspondence to the length for controlling the movement of the machine element in a direction of the associated one of the axes of the machine tool. As a result of this configuration, the need for selection operating elements is eliminated since each of the axes along which a movement is intended has a dedicated touch-sensitive contact area.

According to another advantageous feature of the present invention, at least some of the touch-sensitive contact areas may be arranged on different sides of a housing of the operating device. This provides a particularly clear operating option for the operator.

According to another advantageous feature of the present invention, the touch-sensitive contact area may have a circular shape. This allows the operator operation which is very similar to the conventionally used handwheels. As an alternative, the contact area may have an elongate shape. This provides the operator with a simple option for operating the machine tool.

According to another advantageous feature of the present invention, the operating device can be constructed to generate in response to a contact by an element upon the contact area over a length an output signal in correspondence to the length and direction of the movement for controlling the movement of the machine element in a direction of the axis of the machine tool, with the axis being assigned to the respective movement. This makes it possible to move along a plurality of axes in a particularly simple manner using an individual touch-sensitive contact area.

According to another advantageous feature of the present invention, the element may be represented by an operator's finger or an object.

According to another advantageous feature of the present invention, the operating device may be constructed in the form of a handheld operating device since handwheels are often used, in particular, in handheld operating devices, i.e. operating devices which are carried by a user during operation.

According to another aspect of the present invention, a machine tool includes an operating device having a touch-sensitive contact area and constructed to generate in response to a contact by an element upon the contact area over a length an output signal in correspondence to the length for controlling a movement of a machine element in a direction of an axis of the machine tool.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic top view of a machine tool having incorporated therein an operating device according to the present invention;

FIG. 2 is a schematic illustration of a first exemplary embodiment of an operating device according to the present invention;

FIG. 3 is a schematic illustration of a second exemplary embodiment of an operating device according to the present invention;

FIG. 4 is a schematic illustration of a third exemplary embodiment of an operating device according to the present invention,

FIG. 5 is a schematic illustration of a fourth exemplary embodiment of an operating device according to the present invention, and

FIG. 6 is a schematic illustration of a fifth exemplary embodiment of the operating device according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

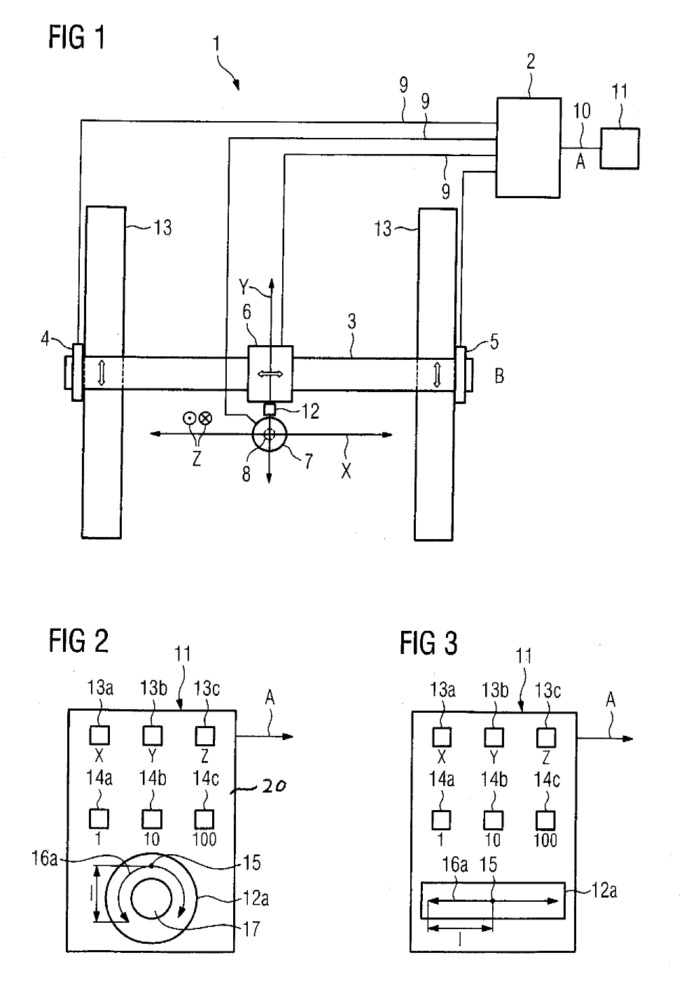

Turning now to the drawing, and in particular to FIG. 1, there is shown a schematic top view of a machine tool, generally designated by reference numeral 1 and having incorporated therein an operating device 11 according to the present invention. The machine tool 1 has a stationary machine bed 13 on which a cross member 3 can be moved in the direction of an axis Y of the machine tool with the aid of a first motor 4 and a second motor 5, which is illustrated using a double-headed arrow in FIG. 1. The machine tool 1 also has a machine element 7 which is in the form of a spindle motor within the scope of the exemplary embodiment. The spindle motor drives a tool 8 in rotation, the spindle motor being coupled to a third motor 6 by means of a fourth motor 12. The third motor 6 can be used to move the spindle motor 7 along the cross member 3 in the direction of an axis X of the machine tool, which is illustrated using a corresponding double-headed arrow in FIG. 1. The motor 12 can be used to move the spindle motor 7 in and out of the plane of the drawing in the direction of an axis Z of the machine tool, that is to say in the illustration according to FIG. 1. In this manner, the spindle motor 7 can be moved in the direction of the axes X, Y and Z using the first motor 4, the second motor 5, the third motor 6 and the fourth motor 12.

The machine tool is controlled and regulated using a control and regulating device 2 of the machine tool 1. The control and regulating device 2 has the control and regulating components needed to control and regulate the machine tool 1 as well as the converters needed to drive the electric motors and is connected to the motors by means of connections 9.

FIG. 1 also illustrates an operating device 11 according to the invention which is preferably in the form of a handheld operating device and is used to operate the machine tool. In this case, the operating device 11 is connected to the control and regulating device 2 via a connection 10 for the purpose of transmitting data. In this case, the operating device 11 generates an output signal A in order to operate the machine tool.

FIG. 2 illustrates a schematic illustration of a first exemplary embodiment of the operating device 11 according to the invention. The operating device 11 has a housing 20 provided with a touch-sensitive contact area 12a which has a circular shape within the scope of this exemplary embodiment. In this case, the circular contact area 12a preferably has a recess 17 which is not touch-sensitive. Within the scope of the exemplary embodiment, the touch-sensitive contact area 12a thus has a circular, in particular annular, touch-sensitive contact area 12a, that is to say it is in the form of a so-called “wheel”, for example.

Furthermore, the operating device 11 has selection operating elements 13a, 13b and 13c for selecting an axis of the machine tool, in the direction of which the machine element is intended to be moved. Within the scope of the exemplary embodiment, the selection operating elements 13a, 13b and 13c are in the form of membrane operating buttons. Each selection operating element 13a, 13b and 13c is provided with a respectively assigned inscription X, Y and Z which indicates which selection operating element can be used to select the relevant axis of the machine tool.

In order to select a proportionality factor, the operating device 11 also has proportionality factor selection operating elements 14a, 14b and 14c which are in the form of membrane buttons within the scope of the exemplary embodiment. Each of the proportionality factor selection operating elements 14a, 14b and 14c is provided with an inscription which is arranged underneath the respective proportionality factor selection operating element 14a, 14b and 14c and indicates the proportionality factor respectively assigned to the proportionality factor selection operating element.

In order to move the machine element in the direction of an axis of the machine tool, the operator selects the appropriate axis, in the direction of which the machine element 7 is intended to be moved, by pressing one of the selection operating elements. The operator selects the axis X of the machine tool 1, for example, by pressing the selection operating element 13a.

A proportionality factor is then selected by pressing one of the proportionality factor selection operating elements 14a, 14b or 14c. The proportionality factor indicates that length, which is covered when an element which touches the contact area 12a is moved, to which the corresponding movement length of the machine element in the direction of the selected axis of the machine tool corresponds. If the operator actuates, for example, the proportionality factor selection operating element 14b by pressing it, this means, for example, that a length of one millimeter which is covered on the contact area by the touching element corresponds to a movement length of the machine element 7 in the direction of the selected axis of 10 micrometers.

The operator then touches a point 15 of the contact area 12a with any desired element, for example his finger, in particular his fingertip, and then moves his fingertip either to the left or to the right in the direction of the double-headed arrow 16a over a particular desired length l which extends, for example, from the point 15 to the left-hand tip of the double-headed arrow 16a. He then withdraws his fingertip from the contact area 12a and in this manner ends contact with the contact area 12a. Since, within the scope of the exemplary embodiment, the axis X of the machine tool was selected, the machine element 7 is moved, within the scope of the exemplary embodiment, to the left in the direction of the axis X of the machine tool 1 in a manner corresponding to the length l in the illustration according to FIG. 1. For this purpose, the operating device 11 generates a corresponding output signal A which is read in as an input signal by the control and regulating device 2. The control and regulating device 2 then controls the movement of the machine element 7 according to the output signal A.

If, starting from the point of contact 15, the operator moves his fingertip over the contact area 12a in the direction of the right-hand arrow of the double-headed arrow 16a, the machine element 7 is accordingly moved to the right in the direction of the axis X of the machine tool 1 in FIG. 1.

It is noted at this point that the element may also be in the form of an object, in particular in the form of a stylus for example.

The basic construction and function of the embodiment illustrated in FIG. 3 essentially correspond to those of the preceding embodiment described in FIG. 2. In FIG. 3, the same elements have therefore been provided with the same reference symbols as in FIG. 2. The fundamental difference is that, in the embodiment according to FIG. 3, the touch-sensitive contact area 12a has an elongate, in particular rectangular, shape. In this case, in a manner corresponding to that described in FIG. 2, the machine element can be moved to the left or to the right over a length l in the direction of a selected axis by moving the element which touches the contact area 12a.

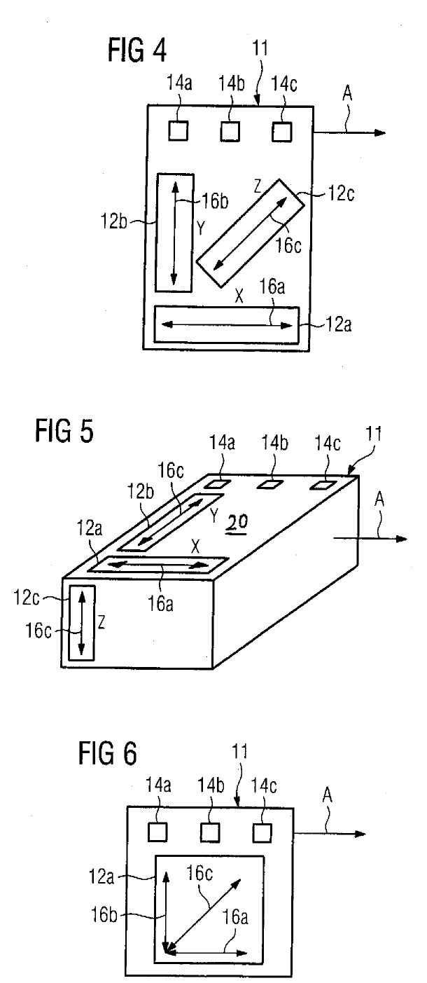

FIG. 4 illustrates another embodiment of the invention. The basic construction of the embodiment illustrated in FIG. 4 corresponds to that of the embodiment described in FIG. 3 and FIG. 2. Instead of an individual touch-sensitive contact area 12a, the operating device 11 has a plurality of touch-sensitive contact areas 12a, 12b and 12c, in which case, when an element which touches the respective contact area 12a, 12b or 12c is moved (indicated by the double-headed arrows 16a, 16b and 16c) over a particular length, the operating device 11 outputs, in a manner corresponding to the length, the output signal A for controlling the movement of the machine element in the direction of the axis X, axis Y or axis Z of the machine tool, which axis is assigned to the respective contact area. Precisely one individual axis of the machine tool 1 is thus permanently assigned to each contact area 12a, 12b and 12c. It is thus possible to dispense with the selection operating elements. If the operator would like to move the machine element 7 in the direction of the axis Z, for example, he moves his fingertip over the contact area 12c, if he would like to move the machine element in the direction of the axis Y, he moves his fingertip over the contact area 12b, and if he would like to move the machine element in the direction of the axis X of the machine tool 1, he moves his fingertip over the contact area 12a.

FIG. 5 illustrates another embodiment of the invention. The basic construction of the invention illustrated in FIG. 5 essentially corresponds to that of the embodiment illustrated above in FIG. 4. In FIG. 5, the same elements have therefore been provided with the same reference symbols as in FIG. 2 and FIG. 4. The fundamental difference to the embodiment according to FIG. 4 is that at least some of the touch-sensitive contact areas are arranged on different sides of the housing 20 of the operating device 11. Within the scope of the exemplary embodiment according to FIG. 5, the touch-sensitive contact area 12c which is used to move the machine element 7 in the direction of the axis Z is arranged on a different side of the housing 20 of the operating device 11 than the touch-sensitive contact areas 12a and 12b. Since, within the scope of the exemplary embodiment, the axis Z is a perpendicular direction of movement running from top to bottom or vice versa for a user standing in front of the machine tool, the touch-sensitive contact area 12c for moving the machine element 7 in the direction of the axis Z is accordingly arranged on a correspondingly arranged side of the housing 20 of the operating device 11, that is say going from top to bottom in the exemplary embodiment. This enables simpler clear operation of the machine tool.

It is also noted at this point that, instead of the three touch-sensitive contact areas illustrated in FIG. 4, only one individual touch-sensitive contact area, in which a respectively associated axis can be correspondingly moved along by means of corresponding movements from left to right or from top to bottom or from the lower left-hand corner of the contact area to the upper right-hand corner or vice versa in each case, may also be present.

FIG. 6 illustrates such an operating device having a touch-sensitive contact area 12a, in which case, when an element which touches the contact area is moved over a length, the operating device outputs, in a manner corresponding to the length and direction of the movement, an output signal A for controlling the movement of the machine element 7 in the direction of an axis of the machine tool 1, which axis is assigned to the respective movement. Otherwise, the method of operation of the embodiment of the invention according to FIG. 6 corresponds to that of the embodiment of the invention according to FIG. 4.

It is noted at this point that, instead of a plurality of axis selection operating elements, the operating device may also have only one individual axis selection operating element, the axis being selected in this case by correspondingly pressing the axis selection operating element several times in succession.

It is also noted at this point that, instead of a plurality of proportionality factor selection operating elements, the operating device may also have only one individual proportionality factor selection operating element, the proportionality factor being selected by correspondingly pressing the proportionality factor selection operating element several times in succession.

It is also noted at this point that, in the exemplary embodiments according to FIG. 4 and FIG. 5, some of the touch-sensitive contact areas may also be circular, so that the operating device has circular and elongate contact areas, or all of the contact areas may be circular.

It is also noted at this point that, instead of using the operating device according to the invention to specify a movement length by which the machine element is intended to be moved (see exemplary embodiment), the speed of movement with which the machine element is intended to move can also be specified. The speed of movement is then proportional to the length l.

It is also noted at this point that the invention can also naturally be used for rotational movements of the machine element. In the case of rotational movements, the term “movement of a machine element in the direction of an axis” is understood, in the sense of the invention, as meaning the rotational movement of the machine element around the orientation (that is the say the orientation vector which runs along the axis of rotation) of the axis of rotation of the movement in space. In this case, the machine element may be in the form of a rotatably driven circular table on which a workpiece can be clamped, for example.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An operating device for operating a machine tool, said operating device comprising a touch-sensitive contact area and constructed to generate in response to a contact by an element upon the contact area over a length an output signal in correspondence to the length for controlling a movement of a machine element in a direction of an axis of the machine tool.

2. The operating device of claim 1, further comprising an axis selection operating element for selecting the axis.

3. The operating device of claim 1 for controlling a movement of the machine element in a direction of three axes defined as x axis, y axis and z axis, and further comprising a plurality of axis selection operating elements which are assigned to the three axes in one-to-one correspondence.

4. The operating device of claim 1, further comprising a proportionality factor selection operating element for selecting a proportionality factor.

5. The operating device of claim 1 for controlling a movement of the machine element in a direction of three axes defined as x axis, y axis and z axis, further comprising a plurality of said touch-sensitive contact area to generate in response to a contact by the element upon one of the contact areas over a length an output signal in correspondence to the length for controlling the movement of the machine element in a direction of the one of the axes of the machine tool.

6. The operating device of claim 5, further comprising a housing, wherein at least some of the touch-sensitive contact areas are arranged on different sides of the housing.

7. The operating device of claim 1, wherein the contact area has a circular shape.

8. The operating device of claim 1, wherein the contact area has an elongate shape.

9. The operating device of claim 1, constructed to generate in response to a contact by the element upon the contact area over a length an output signal in correspondence to the length and to a direction of movement of the element for controlling the movement of the machine element in a direction of the axis assigned to the movement of the element.

10. The operating device of claim 1, wherein the element is represented by an operator's finger or an object.

11. The operating device of claim 1, constructed in the form of a handheld operating device.

12. A machine tool, comprising an operating device having a touch-sensitive contact area and constructed to generate in response to a contact by an element upon the contact area over a length an output signal in correspondence to the length for controlling a movement of a machine element in a direction of an axis of the machine tool.
